(19) United States
(12) Patent Application Publication
(10) Pub. No.: US 2026/0210393 A1
(43) Pub. Date: Jul. 23, 2026

(54) ROTATIONAL SPEED-RESISTANT RINGS

(71) Applicant: SEEGER-ORBIS GmbH, Königstein (DE)

(72) Inventors: Jan Steiger, Essenheim (DE); Stephan Hoelke, Bad Vilbel (DE)

(73) Assignee: SEEGER-ORBIS GmbH, Königstein (DE)

(21) Appl. No.: 19/451,158

(22) Filed: Jan. 16, 2026

(30) Foreign Application Priority Data
Jan. 17, 2025 (EU) 25 152 631.5

(51) Int. Cl. F16B 21/18

(52) U.S. Cl. CPC F16B 21/186

(57) ABSTRACT

The invention relates to a retaining ring (2) for securing a component (4) on a shaft (6), wherein the retaining ring (2) has a securing surface (8) for the contact of the retaining ring (2) with the component (4), wherein the securing surface (8), at least in part, extends at an angle greater than 0° with respect to the radial direction (R) of the retaining ring (2).

### FIELD OF THE INVENTION

The invention relates to a retaining ring for securing a component on a shaft, a system for securing a component on a shaft, and a method for securing a component on a shaft.

### PRIOR ART

Retaining rings for securing a component on a shaft are used to secure components on a rotating shaft. To secure a component on the shaft, the retaining ring is situated in a groove in the shaft in front of the component, with one side of the component resting against a surface of the retaining ring. In addition, the inner diameter of the retaining ring is smaller than the diameter of the shaft, so that the retaining ring rests firmly in the groove, and the component thus rests firmly on the shaft. In this way the component is secured on the shaft, even when the shaft is rotating. The advantage of the retaining ring is that it can be removed from the shaft for uninstalling the component.

Centrifugal forces act on the retaining ring with increasing rotational speed of the shaft, and thus also of the retaining ring. Bending of the retaining ring occurs at high rotational speeds, so that the diameter of the retaining ring becomes larger. Thus, the retaining ring no longer rests firmly in the groove and comes loose from the shaft. As a result, the component as well is no longer secured. Consequently, retaining rings often have only low rotational speed resistance, so that securing the component is ensured only up to a low rotational speed.

Furthermore, play often exists between the retaining ring and the component. As a result, the component can migrate on the shaft in the axial direction. On the one hand this results in imbalance at high rotational speeds. On the other hand, this may damage parts surrounding the migrating components, such as the retaining ring.

Proceeding from this prior art, the object of the present invention is to propose an inexpensive retaining ring that ensures easy handling for installing and uninstalling the retaining ring, and at the same time, good securing at high rotational speeds with little play.

### SUMMARY OF THE INVENTION

According to a first aspect of the invention, the above object is achieved by a retaining ring for securing a component on a shaft, wherein the retaining ring has a securing surface for the contact of the retaining ring with the component, wherein the securing surface, at least in part, extends at an angle greater than 0° with respect to the radial direction of the retaining ring.

The retaining ring may thus be easily and inexpensively manufactured. In addition, the retaining ring secures a component very well in the axial direction. Furthermore, the retaining ring adapts particularly well to any shape of component, since the securing surface extends at an angle greater than 0° with respect to the radial direction of the retaining ring, thus providing the component with a particularly large securing surface with many possible contact points. Moreover, due to the angle of greater than 0°, the securing surface, at least in part, is situated below the component. As a result, the retaining ring does not come out of the groove even at high rotational speeds, and instead is pressed against the component. The retaining ring can thus secure the component well, even at particularly high rotational speeds. In addition, on account of the securing surface the retaining ring can adapt to the component, since the securing surface, at least in part, extends at an angle greater than 0° with respect to the radial direction of the retaining ring. The component can thus rest against various areas of the securing surface, so that the component has little play. Moreover, the retaining ring is easy to install and uninstall.

The retaining ring may be made of a steel, in particular a spring steel or precious metal. For example, the retaining ring may have holes for a gripping tool. The retaining ring may in particular be a locking ring. The locking ring may, for example, have tabs with openings.

The retaining ring may have an inner side. The inner side may face the center of the retaining ring. At the inner side the retaining ring may have an inner surface. For example, the inner surface may be smooth. For example, the inner surface may have no thread. The retaining ring may have an outer side. The outer side may face away from the center of the retaining ring. The distance of the inner side from the outer side may be the width of the retaining ring.

The retaining ring may have a radial direction. For example, the radial direction may extend from the center of the retaining ring to the outer side of the retaining ring. For example, the radial direction may extend from the center to the outer side. The outer radius of the retaining ring may be the distance from the center to the outer side along the radial direction. The outer diameter may be the distance from an outer side, through the center, to the opposite outer side. The outer diameter of the retaining ring may be variable. The radial direction may extend in the direction of the radius of the retaining ring. The radial direction may radiate from the center of the retaining ring. The retaining ring may have a trapezoidal or pentagonal cross section along the radial direction.

The retaining ring may have an axial direction. The axial direction may be perpendicular to the radial direction. The axial direction may extend along the rotational axis of the retaining ring. The axial extension of the retaining ring in the axial direction may be the thickness of the retaining ring. The thickness may be smaller than the outer diameter. The thickness may correspond to at most 20% of the outer diameter.

The retaining ring may be designed to secure the component on the shaft. For example, the retaining ring may thus prevent the component from coming loose from the shaft, even at high rotational speeds. The securing of the component on the shaft may in particular be in the axial direction.

The retaining ring may have a gap. The gap may have a spatial extension. The gap may be between two opposite ends of the retaining ring. For example, the gap may be free of material. For example, there may be no solid bodies, such as metal, in the gap. For example, only air may be present in the gap.

The retaining ring may extend over an angle of less than 360°. The retaining ring may be an open circle. For example, the retaining ring may have an annular design up to the gap that interrupts it. The retaining ring may have only one winding with a gap. Above or below the retaining ring, there may be no further material that is joined to the retaining ring.

The securing surface may have a face that is to come into contact with the component. The securing surface may have a spatial extension.

The contact of the retaining ring with the component may be a connection between the securing surface and the component. The contact of the retaining ring with the component may be an area at which the securing surface rests against the component. The contact of the retaining ring with the component may be a direct connection between the securing surface and the component. For example, there may be no further material between the component and the securing surface. For example, upon contact with the component the retaining ring may have a form-fit connection with the component. For example, the form-fit connection may secure the component in the axial direction and/or in the radial direction.

The securing surface, at least in part, extends at an angle greater than 0° with respect to the radial direction of the retaining ring. The radial direction may extend in parallel to the surfaces that delimit the retaining ring in the axial direction. In particular, the securing surface, at least in part, may extend at an angle greater than 0°, preferably greater than 2°, particularly preferably greater than 5°, with respect to the radial direction of the retaining ring. That the securing surface, at least in part, extends at an angle greater than 0°, preferably greater than 2°, particularly preferably greater than 5°, with respect to the radial direction of the retaining ring may alternatively mean that the securing surface, at least in part, extends at an angle less than 90°, preferably less than 88°, particularly preferably less than 85°, with respect to the axial direction of the retaining ring.

The securing surface may be a boundary of the retaining ring in the axial direction. The securing surface may be joined to a surface of the retaining ring that extends in the radial direction.

When the securing surface, at least in part, extends at an angle greater than 0° with respect to the radial direction of the retaining ring, the cross section of the retaining ring may be trapezoidal in the radial direction. In particular, the cross section of the retaining ring in the radial direction may be quadrangular, pentagonal, or hexagonal. For a flat surface, the angle may be determined from the relationship of a straight line in the flat surface, which preferably has no component in the circumferential direction of the curved surface, with respect to the radial direction. For a curved surface, the angle may be determined from the relationship of a tangent, which preferably has no component in the circumferential direction, with respect to the radial direction. For a curved surface, the angle may advantageously be determined from the relationship of a tangent, which preferably has no component in the circumferential direction, of the curved surface at the midpoint of the curved surface with respect to the radial direction.

According to one exemplary embodiment, the securing surface may be flat or curved.

When the securing surface may be flat, the retaining ring may be manufactured in a particularly simple manner and handled particularly easily. When the securing surface may be curved, the retaining ring may secure the component in a particularly reliable manner.

“Flat” may mean that the securing surface is planar. “Flat” may mean that the securing surface may be two-dimensional.

“Curved” may mean that the securing surface may be three-dimensional.

According to one exemplary embodiment, the flat securing surface, at least in part, may extend at an angle less than or equal to 20°, preferably less than or equal to 15°, preferably less than or equal to 10°, with respect to the radial direction of the retaining ring.

When the flat securing surface, at least in part, may extend at an angle less than or equal to 20°, preferably less than or equal to 15°, preferably less than or equal to 10°, with respect to the radial direction of the retaining ring, the retaining ring may secure a component particularly well and without play. In addition, the retaining ring may be particularly easy to manufacture.

According to one exemplary embodiment, the securing surface may extend over at most 80%, preferably at most 60%, particularly preferably at most 50%, of the width of the retaining ring.

In this way the retaining ring may rest well in the groove, and at the same time may secure the component very well. The retaining ring may thus be particularly reliable for securing.

According to one exemplary embodiment, the retaining ring may have an outer surface, wherein the outer surface may extend at an angle of at most 10°, preferably at most 5°, particularly preferably at most 3°, with respect to the axial direction of the retaining ring, wherein the securing surface may be joined to the outer surface.

In this way, the retaining ring may be provided with an easily grasped outer surface. Installation and uninstallation may thus be facilitated. In addition, damage to the component may be prevented.

The outer surface may in particular extend in the axial direction. The outer surface may be the outermost boundary of the retaining ring in the radial direction. The outer surface may be flat. The outer surface may be situated on the outer side of the retaining ring. The outer surface may be smooth. For example, the outer surface may have no thread.

In one exemplary embodiment, the outer surface may form a curvature.

According to one exemplary embodiment, the retaining ring may have a contact surface, wherein the contact surface may be situated opposite from the securing surface in the axial direction,
a) wherein in particular the contact surface may have a greater angle with respect to the radial direction of the retaining ring than the securing surface, or
b) wherein in particular the contact surface may have the same angle with respect to the radial direction of the retaining ring as the securing surface.

When the retaining ring may have the contact surface, installation of the retaining ring may be facilitated since the retaining ring can be inserted in two directions. In addition, manufacture may be less expensive.

When the contact surface may have a greater angle with respect to the radial direction of the retaining ring than the securing surface, the contact surface may be used for mounting the component. For this purpose, as a result of the contact surface the component can exert a radial force on the contact surface when it is pushed onto the shaft, so that the retaining ring may be pressed into the groove. Installation aids may thus be avoided, so that installation may be facilitated.

The contact surface may in particular be designed for sliding the component over the retaining ring. For example, the contact surface may have an angle of 30° to 60°, preferably 40° to 50°, with respect to the radial direction.

When the contact surface may have the same angle with respect to the radial direction of the retaining ring as the securing surface, installation may be facilitated, so that the orientation of the retaining ring may be irrelevant for the installation. For example, the contact surface may likewise be suitable for securing the component. For example, the contact surface may fulfill the same function as the securing surface.

The contact surface may have a spatial extension. The contact surface may be flat or curved. “Flat” may mean that the contact surface is planar. “Flat” may mean that the contact surface may be two-dimensional. “Curved,” in particular “concave,” may mean that the contact surface may be three-dimensional. “Concave” may mean inwardly curved.

According to one exemplary embodiment, the flat contact surface, at least in part, may extend at an angle less than or equal to 20°, preferably less than or equal to 15°, preferably less than or equal to 10°, with respect to the radial direction of the retaining ring.

For example, the contact surface may have a flat portion and a curved, in particular convex, portion. In particular, the flat portion of the contact surface in the axial direction may be situated closer to the securing surface than is the curved portion. In this way a component may slide particularly easily over the retaining ring, so that installation may be particularly simple.

The contact surface may extend over at most 80%, preferably at most 60%, particularly preferably at most 50%, of the width of the retaining ring. The contact surface may be joined to the outer surface. The securing surface and the contact surface may be joined to one another. For example, the securing surface may abut the contact surface. For example, a boundary of the securing surface may rest against a boundary of the contact surface.

According to one exemplary embodiment, the retaining ring may have a radially extending surface, which may be situated opposite from the securing surface in the axial direction. In this way, the design of the locking ring and thus the manufacture may be particularly simple.

According to a second aspect of the invention, the above object is achieved by a system for securing a component on a shaft, the system comprising a component, a shaft, and a retaining ring according to the invention, the shaft having a groove, the retaining ring being situated in the groove, the component having an abutment surface, and the abutment surface being situated at the securing surface so that the component is secured in the axial direction.

The system is thus easily and inexpensively manufacturable. In addition, the retaining ring secures the component very well. Furthermore, the retaining ring adapts particularly well to any shape of component, since the securing surface extends at an angle greater than 0° with respect to the radial direction of the retaining ring and thus provides the component with a particularly large securing surface with many possible contact points. Moreover, due to the angle greater than 0° the securing surface, at least in part, is situated below the component. As a result, the retaining ring does not come out of the groove even at high rotational speeds, and instead is pressed against the component. The retaining ring thus secures the component, even at particularly high rotational speeds. In addition, on account of the securing surface the retaining ring can adapt to the component, since the securing surface, at least in part, extends at an angle greater than 0° with respect to the radial direction of the retaining ring. The component can thus rest against various areas of the securing surface, so that the component has little play. Moreover, the retaining ring is easy to install and uninstall.

The shaft may be a rotating, in particular elongated, element. The shaft may have a circular cross section. The shaft may be designed to transmit rotational movements and/or torques.

The component may be a bearing, for example. The component may have an opening. The opening may pass through the entire component. The opening may have a larger cross section than the shaft. The shaft may be situated in the opening.

The groove may be an indentation for partially accommodating the retaining ring.

The abutment surface of the component may have a spatial extension.

The abutment surface is situated at the securing surface, so that the component is secured in the axial direction. The abutment surface may be the contact of the retaining ring with the component. The abutment surface and the securing surface may be the sole connection between the retaining ring and the component.

The securing surface may rest against the abutment surface. The securing surface and the abutment surface may be joined directly to one another. For example, there may be no further material between the abutment surface and the securing surface. For example, the securing surface may have a form-fit connection with the abutment surface, wherein the form-fit connection may secure the component in the axial direction and/or in the radial direction.

According to one exemplary embodiment, the diameter of the groove may be smaller than the inner diameter of the retaining ring in the relaxed state, and/or the diameter of the shaft may be larger than the outer diameter of the retaining ring in the contracted state. The diameter of the groove may be the distance between two surfaces of the groove opposite from the center of the groove. The center of the groove may lie on the axis of the shaft. The diameter of the groove may be the maximum extension of the groove in the radial direction. For example, the diameter of the groove may be constant, in particular in the circumferential direction.

The diameter of the shaft may be the distance between two surfaces of the shaft opposite from the center of the shaft. The center of the shaft may lie on the axis of the shaft. The diameter of the shaft may be the maximum extension of the shaft in the radial direction. For example, the diameter of the shaft may be constant, in particular in the circumferential direction.

The inner diameter of the retaining ring may be the distance between two surfaces on the inner side of the retaining ring opposite from the center of the retaining ring. The center of the retaining ring may lie on the axial axis of the retaining ring. The inner diameter of the retaining ring may be the maximum extension of the retaining ring within the inner side of the retaining ring in the radial direction. For example, the inner diameter of the retaining ring may be constant, in particular in the circumferential direction.

The outer diameter of the retaining ring may be the distance between two surfaces on the outer side of the retaining ring opposite from the center of the retaining ring. The center of the retaining ring may lie on the axial axis of the retaining ring. The outer diameter of the retaining ring may be the maximum extension of the retaining ring within the outer sides of the retaining ring in the radial direction. For example, the outer diameter of the retaining ring may be constant, in particular in the circumferential direction.

In the relaxed state of the retaining ring, no load can act on the retaining ring. In the contracted state a load can act on the retaining ring, so that the outer diameter of the retaining ring is smaller than in the relaxed state.

According to one exemplary embodiment, the outer diameter of the retaining ring in the installed state may be smaller than the outer diameter of the retaining ring in the relaxed state.

It may thus be ensured that the retaining ring can press against the component in the installed state. The force on the abutment surface and the securing surface may thus be increased. The friction between the abutment surface and the securing surface may thus be increased, so that the retaining ring can better secure the component. In addition, the play of the component may thus be reduced.

The installed state may be present when the retaining ring may be situated in the groove, and the abutment surface is situated at the securing surface. In the installed state, a restoring force of the retaining ring may strive to increase the outer diameter. In the installed state, no counterforce from the component can act on the restoring force of the retaining ring.

According to one exemplary embodiment, the depth of the groove may be greater than the width of the retaining ring.

In this way the retaining ring may be recessed for installation of the component in the groove. Handling may thus be facilitated.

The depth of the groove may be the radial distance of the surface of the groove from the surface of the shaft. The depth of the groove may be the radial distance of a point on the groove, which may be closer to the center of the shaft, from a point on the shaft which may be closer to the center of the shaft. The depth of the groove may in particular be constant. The width of the retaining ring may in particular be constant.

According to one exemplary embodiment, the abutment surface may be designed as a counterpart for the securing surface, wherein the abutment surface in particular may be flat.

In this way, the abutment surface and the securing surface may rest particularly well against one another, so that the retaining ring can reliably secure the component with particularly little play, even at high rotational speeds. In addition, installation and uninstallation of the system may be particularly simple.

The abutment surface may be designed as a counterpart to the securing surface when the abutment surface may represent the negative shape of the securing surface. For example, the abutment surface may be the inverse image of the securing surface. For example, the abutment surface may be the negative image of the securing surface.

According to one exemplary embodiment, the abutment surface may be a corner of the component.

In this way the retaining ring may be connected to the component in a particularly simple manner, so that the installation and uninstallation may be much be easier. In addition, the retaining ring may secure the component at a corner particularly well in the axial and radial directions at high rotational speeds.

The corner of the component may be an area of the component at which two outer surfaces meet at an angle. The corner of the component may be rounded. The component and the retaining ring may have contact with one another only at the abutment surface and the securing surface.

The component, in particular the corner of the component, may be situated partially above the groove in the radial direction. The component, in particular the corner of the component, may partially overlap the groove in the radial direction. For example, the component, in particular the corner of the component, may extend only partially across the groove in the axial direction. For example, the component, in particular the corner of the component, may partially delimit the groove in the radial direction. For example, the retaining ring may be situated in part between the component, in particular the corner of the component, and the shaft.

According to one exemplary embodiment, the abutment surface may be formed at the outer side of the component facing the shaft.

In this way the retaining ring can engage particularly well with the component, since the retaining ring may be situated between the component and the shaft. Consequently, the retaining ring cannot come loose since widening of the retaining ring is limited by the abutment surface at the outer side of the component facing the shaft. Therefore, the retaining ring can satisfactorily secure the component on the shaft, regardless of the rotational speed.

The outer side of the component facing the shaft may be the inner side of the component. The outer side of the component facing the shaft may be the side of the component that is able to come into contact with the shaft. The outer side of the component facing the shaft may be the radially inwardly pointing, outer side of the component. The outer side of the component facing the shaft may be the surface of the opening in the component.

For example, the component may be situated completely above the groove in the radial direction. For example, the component may completely overlap the groove in the radial direction. For example, the component may extend completely across the entire groove in the axial direction. For example, the component may completely delimit the groove in the radial direction. For example, the retaining ring may be situated completely between the component and the shaft.

The retaining ring may preferably be situated between two opposite outer sides of the component in the axial direction between the two opposite outer sides of the component in the axial direction [sic].

According to one exemplary embodiment, the component may have a further abutment surface, wherein the further abutment surface may be formed at the outer side of the component facing the shaft, wherein the abutment surface may be situated opposite from the further abutment surface in the axial direction, wherein the contact surface may rest against the further abutment surface.

In this way the retaining ring may be secured in both axial directions by means of the abutment surface, the further abutment surface, the securing surface, and the contact surface. The play of the component on the shaft may thus be reduced in a particularly efficient manner, since the component may be secured by the abutment surface and the securing surface and also by the further abutment surface and the contact surface.

The further abutment surface of the component may have a spatial extension.

The further abutment surface may be situated at the contact surface so that the component can be secured in the axial direction. The further abutment surface may be a further contact of the retaining ring with the component. The abutment surface and the securing surface as well as the further abutment surface and the contact surface may be the sole connection between the retaining ring and the component.

The contact surface may rest against the further abutment surface. The contact surface and the further abutment surface may be joined directly to one another. For example, there may be no further material between the further abutment surface and the contact surface. For example, the contact surface may have a form-fit connection with the further abutment surface, wherein the form-fit connection may secure the component in the axial direction and in the radial direction.

For example, the further abutment surface may be designed as a counterpart for the contact surface, wherein the further abutment surface in particular may be flat or curved.

In this way, the further abutment surface and the contact surface may rest against one another particularly well, so that the retaining ring can secure the component with particularly little play, even at high rotational speeds. In addition, the installation of the system may be particularly simple.

The further abutment surface may be designed as a counterpart to the contact surface when the further abutment surface may represent the negative shape of the contact surface. For example, the further abutment surface may be the inverse image of the contact surface. For example, the further abutment surface may be the negative image of the contact surface.

In one exemplary embodiment, the further abutment surface may be formed at the outer side of the component facing the shaft.

In this way the retaining ring can engage particularly well with the component, since the retaining ring may be situated between the component and the shaft. Consequently, the retaining ring cannot come loose since widening of the retaining ring is limited by the abutment surface at the outer side of the component facing the shaft. Therefore, the retaining ring can secure the component on the shaft particularly well, regardless of the rotational speed.

According to a third aspect of the invention, the above object is achieved by a method for securing a component on a shaft by use of a system according to the invention,
in which the retaining ring is situated in the groove,
in which the outer diameter of the retaining ring is decreased by an application of force until the outer diameter of the retaining ring is smaller than the diameter of the shaft,
in which the component is situated on the shaft,
in which the component is situated at least partially or completely above the groove,
in which the application of force is set on the retaining ring,
in which the securing surface is situated at the abutment surface in order to secure the component on the shaft.

The method according to the invention is particularly simple and cost-effective. In addition, the retaining ring protects the component very well. Furthermore, the retaining ring adapts particularly well to any shape of component, since the securing surface extends at an angle greater than 0° with respect to the radial direction of the retaining ring, and thus provides the component with a particularly large securing surface with many possible contact points. Moreover, due to the angle of greater than 0°, the securing surface, at least in part, is situated below the component. As a result, the retaining ring does not come out of the groove even at high rotational speeds, and instead is pressed against the component. The retaining ring can thus secure the component well, even at particularly high rotational speeds. In addition, on account of the securing surface the retaining ring can adapt to the component, since the securing surface, at least in part, extends at an angle greater than 0° with respect to the radial direction of the retaining ring. The component can thus rest against various areas of the securing surface, so that the component has little play. Moreover, the retaining ring is easy to install and uninstall. The method thus offers the advantage that good securing of the component on the shaft is easily and cost-effectively achieved with little play and at high rotational speeds.

The outer diameter of the retaining ring is decreased by an application of force until the outer diameter of the retaining ring is smaller than the outer diameter of the groove. For example, the application of force may be a radial force on the retaining ring. For example, the application of force may be a force on the retaining ring by means of which the ends of the retaining ring may be pressed closer together. For example, the application of force may be a force on the retaining ring against the restoring force of the retaining ring.

The component is situated at least partially or completely above the groove. For example, the component may be situated completely above the groove in the radial direction. For example, the component may completely overlap the groove in the radial direction. For example, the component may extend completely across the entire groove in the axial direction. For example, the component may completely delimit the groove in the radial direction. For example, the retaining ring may be situated completely between the component and the shaft. The component may be situated partially above the groove in the radial direction. The component may partially overlap the groove in the radial direction. For example, the component may extend only partially across the groove in the axial direction. For example, the component may partially delimit the groove in the radial direction. For example, the retaining ring may be partially situated between the component and the shaft.

The application of force on the retaining ring may be set, for example, by applying a radial force to the retaining ring. For example, a force may be applied to the retaining ring, by means of which the ends of the retaining ring may be pressed closer together. For example, the force may be applied to the retaining ring against the restoring force of the retaining ring.

According to one exemplary embodiment, the retaining ring may have the contact surface, wherein the contact surface may be situated opposite from the securing surface in the axial direction, and wherein the contact surface may have a greater angle with respect to the radial direction of the retaining ring than the securing surface.

In the method, the outer diameter of the retaining ring may be decreased by an application of force until the outer diameter of the retaining ring is smaller than the outer diameter of the groove. For example, the force may be transmitted from the component to the contact surface. For example, the component may be pushed across the contact surface. For example, the outer diameter of the retaining ring may be decreased by pushing the component onto the shaft until the outer diameter of the retaining ring is smaller than the outer diameter of the groove. The contact surface may advantageously have a greater angle with respect to the radial direction of the retaining ring than the securing surface. The component may thus slide particularly well over the contact surface, so that the method may be facilitated. In addition, further tools may be dispensed with.

According to one exemplary embodiment, the retaining ring may have the contact surface, wherein the contact surface may be situated opposite from the securing surface in the axial direction, and wherein the contact surface may have the same angle with respect to the radial direction of the retaining ring as the securing surface.

In the method, the retaining ring may be situated independently of the orientation, so that the installation may be facilitated.

In the method, the abutment surface may be the corner of the component. For example, the component may be partially situated above the groove. For example, the corner of the component may be partially situated above the groove. In this way the component may be secured well in the axial direction.

In the method, the abutment surface may be formed at the outer side of the component facing the shaft. For example, the component may be situated completely above the groove. For example, the outer side of the component facing the shaft may be situated completely above the groove. For example, the abutment surface at the outer side facing the shaft may be situated completely above the groove. In this way the component may be secured well in the axial direction.

In the method, the contact surface may be situated at the further abutment surface. The contact surface and the further abutment surface may be joined directly to one another. For example, there may be no further material between the further abutment surface and the contact surface. For example, the contact surface may be connected to the further abutment surface in a form-fit manner, wherein the form-fit connection can secure the component in the axial direction and/or in the radial direction.

In one exemplary embodiment, the further abutment surface may be formed at the outer side of the component facing the shaft. In this way the retaining ring can engage particularly well with the component, since the retaining ring may be situated between the component and the shaft. Consequently, the retaining ring cannot come loose since widening of the retaining ring may be limited by the abutment surface at the outer side of the component facing the shaft. Therefore, the retaining ring can secure the component particularly well, regardless of the rotational speed of the shaft.

The retaining ring may preferably be situated between two opposite outer sides of the component in the axial direction, particularly preferably in the middle between the two opposite outer sides of the component in the axial direction.

According to a fourth aspect of the invention, the above object is achieved by use of a retaining ring according to the invention for securing a component on a shaft, or by use of a system according to the invention for securing a component on a shaft.

Further objects, features, advantages, and aspects of the present invention will become apparent to those skilled in the art from the following description and the appended claims. However, it should be understood that the following description, the appended claims, and the specific examples that describe preferred embodiments of the application are provided only for purposes of illustration. Various revisions and modifications within the spirit and the scope of the disclosed invention will be readily apparent to those skilled in the art when reading the following discussion.

### DEFINITIONS

In general, the following terms preferably have the meanings stated below, unless specified otherwise from the context in which they are used.

The term “include” used here, in addition to its literal meaning, encompasses the terms “essentially comprise” and “comprise,” and specifically refers to same. Thus, the term “include” refers to embodiments in which the subject matter, which “includes” the specifically stated elements, encompasses no further elements, as well as to embodiments in which the subject matter, which “includes” the specifically stated elements, may and/or in fact does encompass further elements. Likewise, the term “have” is to be understood as the term “include,” which also encompasses the terms “essentially comprise” and “comprise,” and refers to same. The term “essentially comprise,” to the extent possible, refers in particular to embodiments in which the subject matter, in addition to the specifically stated elements which essentially comprise the subject matter, encompasses 20% or fewer, in particular 15% or fewer, 10% or fewer, or in particular 5% or fewer, further elements.

### FIGURES

FIG. 1 shows an isometric view of a retaining ring;

FIG. 2 shows an isometric view of a locking ring;

FIG. 3 shows a cross section of a retaining ring;

FIG. 4 shows a cross section of a retaining ring;

FIG. 5 shows a cross section of a retaining ring;

FIG. 6 shows a cross section of a retaining ring;

FIG. 7 shows a cross section of a shaft;

FIG. 8 shows a view of a retaining ring;

FIG. 9 shows a cross section of a system;

FIG. 10 shows a detail from FIG. 9;

FIG. 11 shows a cross section of a system;

FIG. 12 shows a cross section of a system;

FIG. 13 shows a cross section of a system; and

FIG. 14 shows a cross section of a system.

### DETAILED DESCRIPTION

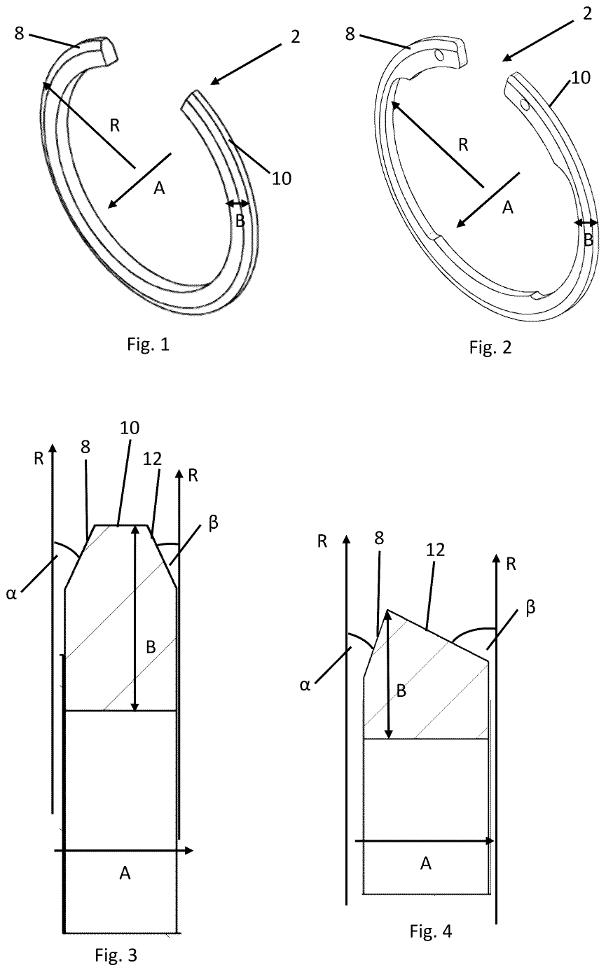

FIG. 1 shows an isometric view of a retaining ring 2 for securing a component 4 on a shaft 6. The retaining ring 2 has a securing surface 8 for the contact of the retaining ring 2 with the component 4. The securing surface 8, at least in part, extends at an angle greater than 0° with respect to the radial direction R of the retaining ring 2.

In the retaining ring 2, the width of the retaining ring, the radial direction R, and the axial direction A are also depicted.

FIG. 2 shows an isometric view of a locking ring 2 for securing a component 4 on a shaft 6. The locking ring 2 has a securing surface 8 for the contact of the locking ring 2 with the component 4. The securing surface 8, at least in part, extends at an angle greater than 0° with respect to the radial direction R of the locking ring 2.

In the locking ring 2, the width of the locking ring, the radial direction R, and the axial direction A are also depicted.

FIG. 3 shows a cross section of a retaining ring 2 for securing a component 4 on a shaft 6. The retaining ring 2 has a securing surface 8 for the contact of the retaining ring 2 with the component 4. The securing surface 8, at least in part, extends at an angle greater than 0° with respect to the radial direction R of the retaining ring 2.

The securing surface 8 is flat. The flat securing surface 8 extends at an angle a less than or equal to 10° with respect to the radial direction R of the retaining ring 2. The securing surface 8 extends over at most 30% of the width B of the retaining ring 2.

The retaining ring 2 has an outer surface 10. The outer surface 10 extends at an angle of at most 3° with respect to the axial direction A of the retaining ring 2. The securing surface 8 is joined to the outer surface 10.

The retaining ring 2 has a contact surface 12. The contact surface 12 is situated opposite from the securing surface 8 in the axial direction. The contact surface 12 has the same angle β with respect to the radial direction R of the retaining ring 2 as the securing surface 8. The securing surface 8 and the contact surface 12 are joined to the outer surface 10.

FIG. 4 shows a cross section of a retaining ring 2 for securing a component 4 on a shaft 6. The retaining ring 2 has a securing surface 8 for the contact of the retaining ring 2 with the component 4. The securing surface 8 in part extends at an angle greater than 0° with respect to the radial direction R of the retaining ring 2.

The securing surface 8 is flat. The flat securing surface 8 extends at an angle a less than or equal to 10° with respect to the radial direction R of the retaining ring 2. The securing surface 8 extends over at most 50% of the width B of the retaining ring 2.

The retaining ring 2 has a contact surface 12. The contact surface 12 is situated opposite from the securing surface 8 in the axial direction. The contact surface 12 has a greater angle β with respect to the radial direction R of the retaining ring 2 than the securing surface 8. The securing surface 8 and the contact surface 12 are joined to one another.

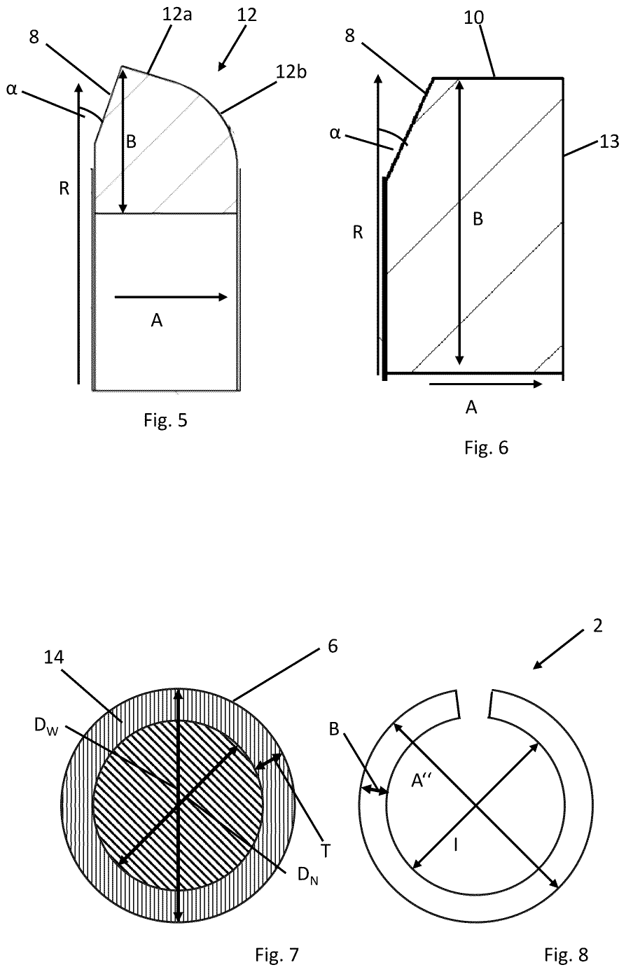

FIG. 5 shows a cross section of a retaining ring 2 for securing a component 4 on a shaft 6. The retaining ring 2 has a securing surface 8 for the contact of the retaining ring 2 with the component 4. The securing surface 8 in part extends at an angle a greater than 0° with respect to the radial direction R of the retaining ring 2.

The securing surface 8 is flat. The flat securing surface 8 extends at an angle a less than or equal to 10° with respect to the radial direction R of the retaining ring 2. The securing surface 8 extends over at most 50% of the width B of the retaining ring 2.

The retaining ring 2 has a contact surface 12. The contact surface 12 is situated opposite from the securing surface 8 in the axial direction. The contact surface 12 has a flat portion 12a and a convex portion 12b. The flat portion 12a of the contact surface 12 is situated closer to the securing surface 8 in the axial direction than is the convex portion 12b. The securing surface 8 and the contact surface 12 are joined to one another.

FIG. 6 shows a cross section of a retaining ring 2 for securing a component 4 on a shaft 6. The retaining ring 2 has a securing surface 8 for the contact of the retaining ring 2 with the component 4. The securing surface 8 in part extends at an angle greater than 0° with respect to the radial direction R of the retaining ring 2.

The securing surface 8 is flat. The flat securing surface 8 extends at an angle a less than or equal to 10° with respect to the radial direction R of the retaining ring 2. The securing surface 8 extends over at most 50% of the width B of the retaining ring 2.

The retaining ring 2 has a radially extending face 13 that is situated opposite from the securing surface 8 in the axial direction A.

FIG. 7 shows a cross section of a shaft 6. The shaft 6 and the groove 14 are apparent in FIG. 7. Also depicted are the diameter D_{N} of the groove 14, the diameter D_{W} of the shaft 6, and the depth T of the groove 14.

FIG. 8 shows a view of a retaining ring 2. FIG. 7 [sic; 8] depicts the inner diameter I of the retaining ring 2 in the relaxed state, the outer diameter A″ of the retaining ring 2 in the relaxed state, and the width B of the retaining ring 2. The outer diameter A″ of the retaining ring 2 in the relaxed state is larger than the outer diameter A′ of the retaining ring 2 in the installed state. The outer diameter A′ of the retaining ring 2 in the installed state is larger than the outer diameter A′ of the retaining ring 2 in the contracted state.

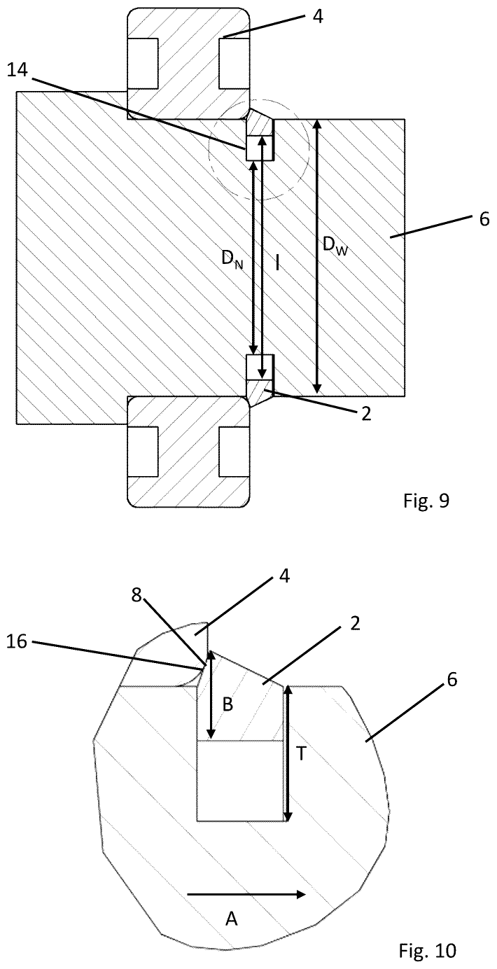

FIG. 9 shows a cross section of a system for securing a component 4 on a shaft 6. The system comprises a component 4, a shaft 6, and a retaining ring 2 according to the invention. The shaft 6 includes a groove 14, the retaining ring 2 being situated in the groove 14.

FIG. 10 is a detail from FIG. 9. As is apparent in FIG. 10, the component 4 has an abutment surface 16. The abutment surface 16 is situated at the securing surface 8, so that the component 4 is secured in the axial direction A.

As shown in FIG. 9, the diameter D_{N} of the groove 14 is smaller than the inner diameter I of the retaining ring 2 in the relaxed state. The diameter D_{W} of the shaft 6 is larger than the outer diameter A of the retaining ring 2 in the contracted state. In addition, the outer diameter A′ of the retaining ring 2 in the installed state is smaller than the outer diameter A″ of the retaining ring 2 in the relaxed state.

As shown in FIG. 10, the depth T of the groove 14 is greater than the width B of the retaining ring 2.

The abutment surface 16 has a curved design. The securing surface 8 is flat. Alternatively, the abutment surface 16 could also be flat. The abutment surface 16 is a corner of the component 4.

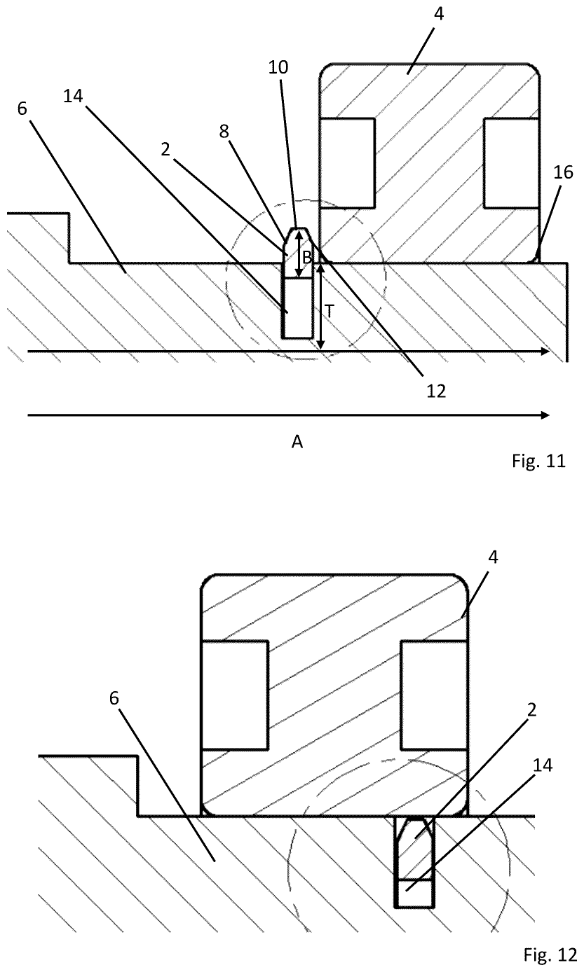

The method for securing a component 4 on a shaft 6 is described with reference to FIGS. 11 through 13. FIGS. 11 through 13 show a cross section of a system for securing a component 4 on a shaft 6 at various points in time of the method.

FIG. 11 shows a cross section of a system for securing a component 4 on a shaft 6. The system comprises a component 4, a shaft 6, and a retaining ring 2 according to the invention. The shaft 6 includes a groove 14, the retaining ring 2 being situated in the groove 14. The component 4 has an abutment surface 16.

The diameter D_{N} of the groove 14 is smaller than the inner diameter I of the retaining ring 2 in the relaxed state. The diameter D_{W} of the shaft 6 is larger than the outer diameter A of the retaining ring 2 in the contracted state. In addition, the outer diameter A′ of the retaining ring 2 in the installed state is smaller than the outer diameter A″ of the retaining ring 2 in the relaxed state. The depth T of the groove 14 is greater than the width B of the retaining ring 2.

The securing surface 8 is flat. The abutment surface 16 is convex. The abutment surface 16 is formed at the outer side of the component 4 facing the shaft 6.

As is apparent in FIG. 11, the retaining ring 2 is situated in the groove 14. The outer diameter A of the retaining ring 2 is subsequently decreased by an application of force until the outer diameter A″ of the retaining ring 2 is smaller than the diameter D_{W} of the shaft 6. In addition, the component 4 is situated on the shaft 6.

As is apparent in FIG. 12, the component 4 is pushed along the shaft 6 and across the groove 14. The component 4 is hereby situated completely above the groove 14. Alternatively, the component 4 could be situated partially above the groove 14.

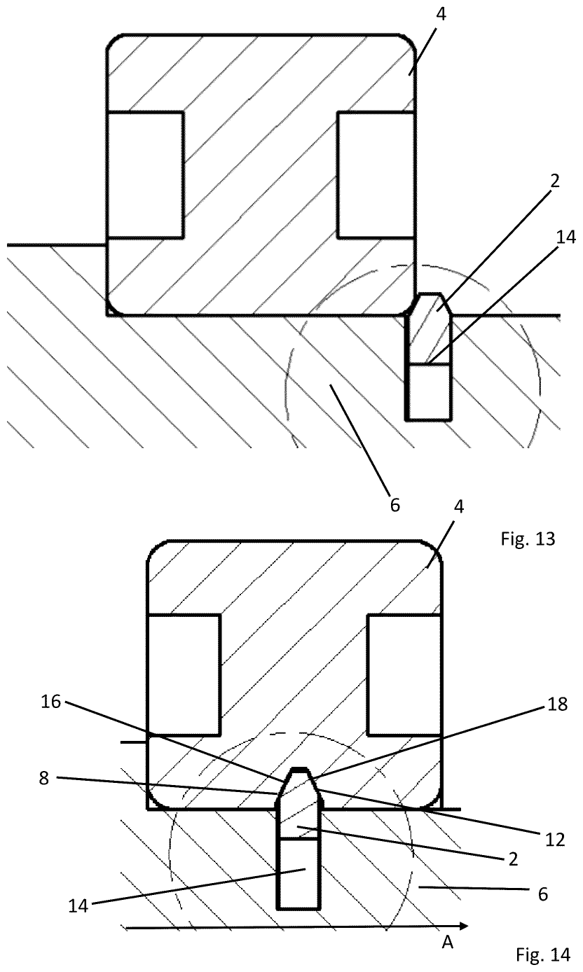

As is apparent in FIG. 13, the component 4 is situated partially above the groove 14. The application of force on the retaining ring 2 is subsequently set. Lastly, the securing surface 8 is arranged at the abutment surface 16 in order to secure the component 4 on the shaft 6.

FIG. 14 shows a cross section of a system for securing a component 4 on a shaft 6. The system comprises a component 4, a shaft 6, and a retaining ring 2 according to the invention. The shaft 6 includes a groove 14, the retaining ring 2 being situated in the groove 14.

As is apparent in FIG. 14, the component 4 has an abutment surface 16. The abutment surface 16 is situated at the securing surface 8, so that the component 4 is secured in the axial direction A. The abutment surface 16 has a curved design. The securing surface 8 is flat.

The retaining ring 2 has a contact surface 12. The contact surface 12 is situated opposite from the securing surface 8 in the axial direction. The component 4 has a further abutment surface 18. The further abutment surface 18 is formed at the outer side of the component 4 facing the shaft 6, with the abutment surface 16 being situated opposite from the further abutment surface 18 in the axial direction A. The contact surface 12 rests against the further abutment surface 18.

1. A retaining ring for securing a component on a shaft,
wherein the retaining ring has a securing surface for the contact of the retaining ring with the component,
wherein the securing surface, at least in part, extends at an angle greater than 0° with respect to the radial direction of the retaining ring.

2. The retaining ring according to claim 1, wherein
the securing surface is flat.

3. The retaining ring according to claim 1, wherein
the flat securing surface, at least in part, extends at an angle less than or equal to 20°, preferably less than or equal to 15°, preferably less than or equal to 10°, with respect to the radial direction of the retaining ring.

4. The retaining ring according to claim 1,
wherein
the securing surface extends over at most 80%, preferably at most 60%, particularly preferably at most 50%, of the width of the retaining ring.

5. The retaining ring according to claim 1,
wherein
the retaining ring has an outer surface,
wherein the outer surface extends at an angle of at most 10°, preferably at most 5°, particularly preferably at most 3°, with respect to the axial direction of the retaining ring,
wherein the securing surface is joined to the outer surface.

6. The retaining ring according to claim 1,
wherein
the retaining ring has a contact surface,
wherein the contact surface is situated opposite from the securing surface in the axial direction,
a) wherein in particular the contact surface has a greater angle with respect to the radial direction of the retaining ring than the securing surface, or
b) wherein in particular the contact surface has the same angle with respect to the radial direction of the retaining ring as the securing surface.

7. A system for securing a component on a shaft, wherein the system comprises a component, a shaft, and a retaining ring according to claim 1,
wherein the shaft has a groove,
wherein the retaining ring is situated in the groove,
wherein the component has an abutment surface,
wherein the abutment surface is situated at the securing surface, so that the component is secured in the axial direction.

8. The system according to claim 7,
wherein
the diameter of the groove is smaller than the inner diameter of
the retaining ring in the relaxed state, and/or
the diameter of the shaft is larger than the outer diameter of
the retaining ring in the contracted state.

9. The system according to claim 7,
wherein
the outer diameter of the retaining ring in the installed state is smaller than the outer diameter of the retaining ring in the relaxed state.

10. The system according to claim characterized in that wherein the depth of the groove is greater than the width of the retaining ring.

11. The system according to claim 7,
wherein
the abutment surface is designed as a counterpart for the securing surface,
wherein the abutment surface in particular is flat or curved, in particular convex.

12. The system according to claim 7,
wherein
the abutment surface is a corner of the component.

13. The system according to claim 7,
wherein
the abutment surface is formed at the outer side of the component facing the shaft.

14. The system according to claim 13,
wherein
the component has a further abutment surface,
wherein the further abutment surface is formed at the outer side of the component facing the shaft,
wherein the abutment surface is situated opposite from the further abutment surface in the axial direction,
wherein the contact surface rests against the further abutment surface.

15. A method for securing a component on a shaft by use of a system according to claim 7,
in which the retaining ring is situated in the groove,
in which the outer diameter of the retaining ring is decreased by an application of force until the outer diameter of the retaining ring is smaller than the diameter of the shaft,
in which the component is situated on the shaft,
in which the component is situated at least partially or completely above the groove,
in which the application of force is set on the retaining ring,
in which the securing surface is situated at the abutment surface in order to secure the component on the shaft.
